(19) United States
(12) Patent Application Publication
(10) Pub. No.: US 2023/0383051 A1
(43) Pub. Date: Nov. 30, 2023

(54) BIODEGRADABLE THERMOPLASTIC MATERIALS

(71) Applicant: Dizolv, Inc., Brentwood, CA (US)

(72) Inventors: Alex HSU, Belmont, MA (US); Christopher W. LIVESEY, Norwood, MA (US); Sam ELLMAN, Somerville, MA (US)

(21) Appl. No.: 18/303,967

(22) Filed: Apr. 20, 2023

Related U.S. Application Data
(60) Provisional application No. 63/332,850, filed on Apr. 20, 2022.
(60) Provisional application No. 63/346,481, filed on May 27, 2022.

(51) Int. Cl. C08G 63/08; C08L 3/02; C08L 1/14; C08K 3/24; C08K 5/053; C08K 5/11; B29C 48/00; B29C 48/40

(52) U.S. Cl. CPC C08G 63/08; C08L 3/02; C08L 1/14; C08K 3/24; C08K 5/053; C08K 5/11; B29C 48/022; B29C 48/40; C08G 2230/00; C08L 2205/03; B29K 2001/14

(57) ABSTRACT

The present invention provides an ocean compostable thermoplastic material that may be used in final consumer products, for example, plastic packaging, shrink wrap, and food storage bags.

### CROSS-REFERENCE TO RELATED PATENT APPLICATIONS

This patent application claims priority to U.S. Provisional Patent Application No. 63/332,850, filed Apr. 20, 2022, and U.S. Provisional Patent Application No. 63/346,481, filed May 27, 2022, the disclosures of both of which are herein incorporated in their entirety.

### BACKGROUND

### 1. Field

The present disclosure relates to biodegradable (ocean compostable) thermoplastic materials and methods of making, and final products comprising the biodegradable (ocean compostable) thermoplastic materials.

### 2. Description of Related Art

Plastic is a synthetic organic polymer made from petroleum with properties ideally suited for a wide variety of applications including: packaging, building and construction, household and sports equipment, vehicles, electronics and agriculture. Over 300 million tons of plastic are produced every year, half of which is used to create single-use items such as shopping bags, cups and straws. If discarded improperly, plastic waste can harm the environment and biodiversity. International Union for Conservation of Nature Issues Brief “Marine Plastic Pollution” (November 2021).

At least 14 million tons of plastic end up in the ocean every year. Plastic debris is currently the most abundant type of litter in the ocean, making up 80% of all marine debris found from surface waters to deep-sea sediments. Plastic is found on the shorelines of every continent, with more plastic waste found near popular tourist destinations and densely populated areas. International Union for Conservation of Nature Issues Brief “Marine Plastic Pollution” (November 2021).

The main sources of plastic debris found in the ocean are land-based, coming from urban and stormwater runoff, sewer overflows, littering, inadequate waste disposal and management, industrial activities, tire abrasion, construction and illegal dumping. Ocean-based plastic pollution originates primarily from the fishing industry, nautical activities and aquaculture.

Under the influence of solar ultra-violet (UV) radiation, wind, currents and other natural factors, plastic breaks down into small particles called microplastics (particles smaller than 5 mm) or nanoplastics (particles smaller than 100 nm). The small size makes them easy for marine life to ingest accidentally. International Union for Conservation of Nature Issues Brief “Marine Plastic Pollution” (November 2021).

Many countries lack the infrastructure to prevent plastic pollution such as: sanitary landfills; incineration facilities; recycling capacity and circular economy infrastructure; proper management and disposal of waste systems. This leads to ‘plastic leakage’ into rivers and the ocean. The legal and illegal global trade of plastic waste may also damage ecosystems, where waste management systems are not sufficient to contain plastic waste. International Union for Conservation of Nature Issues Brief “Marine Plastic Pollution” (November 2021).

There exists a need in the art for ocean compostable polymers that be used as films, including for packaging.

### BRIEF SUMMARY

In an embodiment, a biodegradable thermoplastic material can comprise (a) 20% to 50% by weight a biodegradable polymer and (b) 1% to 80% by weight a plasticizer, wherein the biodegradable thermoplastic material optionally further comprises (c) 5% to 40% by weight a biodegradable polyol; (d) 1% to 20% by weight a filler; (e) 1% to 20% by weight a crosslinker; (f) 1% and 15% by weight a tackifier, or a combination thereof.

In an embodiment, a biodegradable thermoplastic material can comprise (a) 20% to 50% by weight a biodegradable polymer; (b) 1% to 50% by weight a plasticizer, (c) 5% to 40% by weight a biodegradable polyol; (c) 1% to 20% by weight a filler; (d) 1% to 20% by weight a crosslinker; (e) 1% and 15% by weight a tackifier.

In an embodiment, the biodegradable polymer can be poly(ε-caprolactone) average Mₙ (PCL-M.80K); polyethylene glycol 400 (PEG 400); polyethylene glycol 1500 (PEG 1500); polyvinyl alcohol MW 13,000-23,000; polyvinyl alcohol MW 85,000-146,000; polycaprolactone diol MW=1 kDa to 3 kDa, polyhydroxybutyrate (PHB) MW 20 kDa to 50 kDa; polylactic acid (PLA); or a mixture thereof.

In an embodiment, the biodegradable polymer can be a copolymer. The copolymer can be polyvinyl alcohol (PVA) MW 85,000; polyvinyl alcohol (PVA) MW 146,000; polyhydroxybutyrate (PHB); polylactic acid (PLA); and poly(ε-caprolactone) (PCL) MW 80,000; or a mixture thereof. The biodegradable polymer can be poly(ε-caprolactone) (PCL) MW 80,000 at about 40% by weight. In an embodiment, the biodegradable polymer can be poly(ε-caprolactone) (PCL) MW 80,000.

In an embodiment, the biodegradable polymer can be in an amount of 20% to 90% by weight, 20% to 60% by weight, 30% to 50% by weight, 35% to 45% by weight, 32% to 45% by weight, 35% to 60% by weight, 33% to 49% by weight, 30% to 40% by weight, 35% to 45% by weight, or 36% to 57% by weight. The biodegradable polymer can be in an amount of about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, or 60% by weight. The biodegradable polymer can be in an amount of about 40% by weight (wt %).

In an embodiment, the biodegradable polyol can be potato starch, wheat starch, rice starch, chitosan, Arrowroot starch, corn starch, optionally corn starch comprising about 20% amylose by weight, Hylon® VII (unmodified corn start comprising about 70% amylose by weight), erythritol, hydrogenated starch hydrolysates, isomalt, lactitol, maltitol, mannitol, sorbitol, xylitol, or a combination thereof. The biodegradable polyol can be corn (maize) starch. The biodegradable polyol can be in an amount of about 24% by weight. The biodegradable polyol can be corn starch in amount of about 24% by weight.

In an embodiment, the biodegradable polyol can be in an amount of 1% to 30% by weight, 10% to 20% by weight, 10% to 50% by weight, 15% to 27% by weight, 12% to 25% by weight, or 15% to 30% by weight, 13% to 29% by weight, 14% to 22% by weight, 15% to 25% by weight, or 16% to 27% by weight. The biodegradable polyol can be in an amount of 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30% by weight. The biodegradable polyol can be in an amount of 20% by weight.

In an embodiment, the filler can be carboxymethyl cellulose, hydroxyethyl cellulose, chitosan, cellulose acetate, cellulose acetate propionate, hydroxypropyl methyl cellulose, hydroxypropyl cellulose, methyl cellulose, microcrystalline cellulose (MCC), or a combination thereof. The filler can be cellulose acetate propionate, hydroxypropyl methyl cellulose, hydroxypropyl cellulose, methyl cellulose, microcrystalline cellulose (MCC), or a combination thereof. The filler can be microcrystalline cellulose (MCC).

In an embodiment, the filler can be in an amount of 0% an 20%, 1% to 20% by weight, 1% to 10% by weight, 1% to 17% by weight, 1% to 15% by weight, or 5% to 10% by weight, 3% to 9% by weight, 4% to 12% by weight, 5% to 20% by weight, or 6% to 17% by weight. The filler can be in an amount of 1%, 2%, 3%, 4%, 5%, 6%, 7%, 8%, 9%, 10%, 11%, 12%, 13%, 14%, 15%, 16%, 17%, 18%, 19%, or 20% by weight. The filler can be in an amount of 5% by weight. The filler can be microcrystalline cellulose (MCC) in about 5% in weight.

In an embodiment, the crosslinker can be glutaraldehyde, glyoxal, succinic anhydride, maleic anhydride, boric acid, citric acid, potassium persulphate, hydrogen peroxide, benzoyl peroxide, or a combination thereof. The crosslinker can be maleic anhydride, potassium persulphate, benzoyl peroxide, boric acid, or a combination thereof. The crosslinker can be boric acid. The crosslinker can be boric acid at an amount of about 5% by weight.

In an embodiment, the crosslinker can be in an amount of 1% to 20% by weight, 1% to 10% by weight, 1% to 17% by weight, 1% to 15% by weight, or 5% to 10% by weight, 3% to 9% by weight, 4% to 12% by weight, 5% to 20% by weight, or 6% to 17% by weight. The crosslinker can be in an amount of about 1%, 2%, 3%, 4%, 5%, 6%, 7%, 8%, 9%, 10%, 11%, 12%, 13%, 14%, 15%, 16%, 17%, 18%, 19%, or 20% by weight. The crosslinker can be in an amount of 5% by weight.

In an embodiment, the plasticizer can be in an amount of 1% to 50% by weight. The plasticizer can be in an amount of 1% to 20% by weight, 5% to 40% by weight, 3% to 20% by weight, 1% to 30% by weight, 15% to 35% by weight, 5% to 45% by weight, 25% to 60% by weight, 30% to 40% by weight, 1% to 40% by weight, 5% to 35% by weight, or 15% to 55% by weight.

In an embodiment, the plasticizer can be in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50% by weight. The plasticizer can be in an amount of about 3% by weight. The plasticizer can be in an amount of about 20% by weight.

In an embodiment, the plasticizer can be triethyl citrate, tributyl citrate, tribuytl acetyl citrate, triacetin, carboxylic acids, optionally C₆-C₁₈ carboxylic acids, dodecanoic acid, stearic acid, behenic acid, glycerol, or a combination thereof. The plasticizer can be triethyl citrate.

In an embodiment, the plasticizer can be a melting temperature modifier. The melting temperature modifier can be triethyl citrate, tributyl citrate, tribuytl acetyl citrate, triacetin, carboxylic acids, optionally C₆-C₁₈ carboxylic acids, dodecanoic acid, stearic acid, behenic acid, glycerol, or a combination thereof. The melting temperature modifier can be glycerol. The melting temperature modifier can be tributyl citrate (TBC).

In an embodiment, the material can comprise 1% to 30% by weight a melting point modifier. The melting temperature modifier can be in an amount of 1% to 10% by weight, 3% to 10% by weight, 4% to 7% by weight, 5% to 8% by weight, or 6% to 7% by weight, 13% to 20% by weight, 4% to 17% by weight, 5% to 20% by weight, or 6% to 17% by weight. The melting temperature modifier can be in an amount of about 1%, 2%, 3%, 4%, 5%, 6%, 7%, 8%, 9%, 10%, 11%, 12%, 13%, 14%, 15%, 16%, 17%, 18%, 19%, or 20% by weight. The melting temperature modifier can be in an amount of 20% by weight.

In an embodiment, the plasticizer can be a lubricant. The lubricant can be triethyl citrate, tributyl citrate, tribuytl acetyl citrate, triacetin, carboxylic acids, optionally C₆-C₁₈ carboxylic acids, dodecanoic acid, stearic acid, behenic acid, castor oil, behenic acid, adipic acid, dodecanol, or a combination thereof. The lubricant can be triethyl citrate. The lubricant can be in an amount of 1% to 10% by weight, 3% to 30% by weight, 4% to 7% by weight, 5% to 8% by weight, or 6% to 7% by weight, 13% to 20% by weight, 4% to 17% by weight, 5% to 20% by weight, or 6% to 17% by weight. The lubricant can be in an amount of about 1%, 2%, 3%, 4%, 5%, 6%, 7%, 8%, 9%, 10%, 11%, 12%, 13%, 14%, 15%, 16%, 17%, 18%, 19%, 20% 21%, 22%, 23%, 24%, 25%, 26%, 27%, 28%, 29%, or 30% by weight. The lubricant can be in an amount of 5% by weight.

In an embodiment, the polycaprolactone diol MW can be 1 kDa, 2 kDa, or 3 kDa. The polycaprolactone diol MW can be 2 kDa.

In an embodiment, the polyhydroxybutyrate (PHB) MW can be 20 kDa, 25 kDa, 30 kDa, 35 kDa, 40 kDa, 45 kDa, or 50 kDa. The polyhydroxybutyrate (PHB) MW can be 40 kDa.

In an embodiment, the tackifier can be terpene, rosin methyl ester, partially hydrogenated rosin ester, hydrogenated gum rosin alcohol, Eastman Permalyn 6110 Synthetic resin® (pentaerythritol ester of rosin), gum rosin, pentaerythritol gum rosin ester, beeswax, plant oils, or a combination thereof. The tackifier can be pentaerythritol gum rosin ester, for example Eastman Permalyn 6110 Synthetic resin® (pentaerythritol ester of rosin).

In an embodiment, the tackifier can be in an amount of 1% and 15% by weight, 1% to 10% by weight, 3% to 10% by weight, 4% to 7% by weight, 5% to 8% by weight, or 6% to 7% by weight. The tackifier can be in an amount of about 1%, 2%, 3%, 4%, 5%, 6%, 7%, 8%, 9%, or 10% by weight. The tackifier can be in an amount of about 5% by weight. The tackifier can be in an amount of about 3% by weight.

In an embodiment, the biodegradable thermoplastic material described herein is ocean compostable.

In an embodiment, packaging can comprise the biodegradable thermoplastic material described herein. The packaging can be plastic packaging, stretch wrap, shrink wrap, food storage bags, or a combination thereof. The packaging can be stretch wrap.

In an embodiment, an article of manufacture may be packaged in the biodegradable thermoplastic material described herein.

In an embodiment, the method for making the biodegradable thermoplastic material described herein can comprise mixing the components and extrude to produce the biodegradable thermoplastic material described herein, optionally molding the material into pellets. The extruder can be configured to allow the components combine and form the material. The extruder can be configured to vent steam, water, or a combination thereof. The biodegradable thermoplastic material described herein may be provided in the form of pellets.

In an embodiment, the components are mixed at a temperature between about 60° C. to 200° C. The temperature can be between about 180° C. and 200° C., optionally about 140° C.

In an embodiment, the dwell time in the extruder can be between 1-60 minutes. The dwell time in the extruder can be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes.

In an embodiment, the extruder can be a single extruder.

In an embodiment, the extruder can be a twin extruder.

### DETAILED DESCRIPTION

Before the subject disclosure is further described, it is to be understood that the disclosure is not limited to the particular embodiments of the disclosure described below, as variations of the particular embodiments may be made and still fall within the scope of the appended claims. It is also to be understood that the terminology employed is for the purpose of describing particular embodiments, and is not intended to be limiting. Instead, the scope of the present disclosure will be established by the appended claims.

### Definitions

Unless otherwise indicated, all terms used herein have the same meaning as they would to one skilled in the art.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

“Substantially free,” as used herein, refers broadly to the presence of a specific component in an amount less than 1%, preferably less than 0.1% or 0.01%. More preferably, the term “substantially free” refers broadly to the presence of a specific component in an amount less than 0.001%. The amount may be expressed as w/w or w/v depending on the composition. Biodegradable Thermoplastic Material

Single-use disposable plastic products (e.g., plastic packaging, shrink wrap, food storage bags) are contributing to the current climate change problem and are becoming a significant driving force behind ocean waste. Out of the 40 M tons of plastic products produced annually in the US, an estimated 8 M pounds end up in the ocean every year. Consequently, microplastics have infiltrated into most living systems and have led to many downstream negative effects such as human plastic consumption (it is estimated that humans consume ˜40 lbs. of plastic in a lifetime), contaminating food sources, environmental disruption and ocean life destruction, as well as an increased dependency on petroleum-based products. US consumers are also becoming more concerned regarding the ocean waste problem.

To address these issues, some manufacturers are attempting to adopt “closed-loop recycling” solutions that require consumers to recycle empty plastic containers. However, these current infrastructures are failing as recyclers are underperforming and not meeting requirements. Recycling rules are not straightforward, therefore leading to confusion and exhaustion for consumers. In return, this prevents successful recycling efforts via closed-loop options. Additionally, most existing US disposable plastic companies are not motivated to commit resources to develop plastic alternative materials as it is much quicker and cheaper to leverage oil to create plastics. Thus, their R&D efforts to address the ocean waste problem are slow (or nonexistent). To improve plastic's biocompatibility, some explored using additive-based mixtures and catalysts to break down plastics into “harmless constituents.” These efforts have not been successful and many of the additives investigated led to more dangerous microplastics and byproducts.

The inventors created an ocean-friendly, single-use thermoplastic alternative material that can be biodegradable in the ocean without generating microplastics or harmful byproducts. The thermoplastic alternative composites described herein comprise polysaccharides that exhibit strong mechanical properties, excellent elasticity and flexibility, and electrostatic properties. The inventors surprisingly discovered that a blended mixtures described herein, are lightly grafted and crosslinked using glutaraldehyde and other chemical modifications biodegrade in ocean conditions (e.g., 20° C., salt water, UV radiation). This approach enables the generation of low-density, water sensitive composites with thermoplastic that enables for controlled biodegradability in the ocean. By replacing single-use plastics with the biodegradable thermoplastic materials described herein can also alleviate the burden on consumers to “properly” dispose of single-use plastics by avoiding the need to be recycled using traditional, inefficient methods. Other advantages include, but are not limited to: (1) the ability to exhibit comparable mechanical properties to current plastic disposable products (e.g., shrink wrap); (2) ability to be readily biodegradable and ocean compostable into harmless byproducts/constituents without generating any microplastics (under aerobic and anaerobic conditions); (3) a production process can seamlessly be integrated into manufacturer's current processes and systems; and, (4) a cost-effective solution to offer an affordable product in the commercial market.

The biodegradable thermoplastic material described herein exhibits similar mechanical properties comparable to Sigma Stretch Film (one of the most commonly used stretch film in packages). The biodegradable thermoplastic material described herein can stretch 200% of its original size, optionally up to 240% of its original size, exhibiting similar elasticity to commercially available stretch film. The inventors found that the grafting and crosslinking between chitosan and starch form the backbone of the biodegradable thermoplastic material described herein. The biodegradable thermoplastic material described herein exhibits excellent mechanical and static properties, as well as have controlled biodegradation when exposed to the ocean without becoming brittle due to water penetration.

The biodegradable thermoplastic material described herein exhibits mechanical, durability, and static properties to compare those to the Sigma Stretch Film. The biodegradable thermoplastic material described herein are fully decomposable when exposed to the ocean, under anaerobic and anaerobic conditions. The biodegradable thermoplastic material described herein produces harmless constituents without generating any microplastics.

The biodegradable thermoplastic material described herein can be used to replace single-use plastic disposable products. The biodegradable thermoplastic material described herein have the following advantages, among others: (1) delivering a product that can exhibit comparable mechanical properties to current plastic disposable products; (2) the production process can seamlessly be integrated into current manufacturing systems; and, (3) cost-effective alternative to single-use plastics that is an affordable solution in the commercial market.

The biodegradable thermoplastic material described herein can comprise (a) 20% to 50% by weight a biodegradable polymer; (b) 5% to 40% by weight a biodegradable polyol; (c) 1% to 20% by weight a filler; (d) 1% to 20% by weight a crosslinker; (e) 1% to 30% by weight a melting temperature modifier; (f) 1% to 20% by weight a lubricant; and (g) 1% and 15% by weight a tackifier.

The biodegradable thermoplastic material described herein is ocean compostable. For example, when present in the ocean for about 6-24 months, e.g., in salt water and about (or above) the biodegradable thermoplastic material described may decompose into benign constituents.

The tensile strength of the material is 15 MPa, elongation is 700%, biodegrades in 6 months under room temperature composting conditions.

### Biodegradable Polymer

The biodegradable thermoplastic material described herein can comprise a biodegradable polymer. The biodegradable polymer can be poly(ε-caprolactone) average Mₙ 80,000 (PCL-Mₙ80K); polyethylene glycol 400 (PEG 400); polyethylene glycol 1500 (PEG 1500); polyvinyl alcohol MW 13,000-23,000; polyvinyl alcohol MW 85,000-146,000; polycaprolactone diol MW=2kDa Polyhydroxybutyrate (PHB) MW=40kDa; polylactic acid (PLA); or a mixture thereof. The biodegradable polymer can be a copolymer. The polycaprolactone diol MW may be between about 1 kDa and 3 kDa, e.g., 1 kDa, 2kDa, 3 kDa. The polyhydroxybutyrate MW (molecular weight) can be between about 20 kDa and 50 kDa, e.g., 20 kDa, 25 kDa, 30 kDa, 35 kDa, 40 kDa, 45 kDa, and 50 kDa. The copolymer can be polyvinyl alcohol (PVA) MW 85,000; polyvinyl alcohol (PVA) MW 146,000; Polyhydroxybutyrate (PHB); polylactic acid (PLA); and poly(ε-caprolactone) (PCL) MW or a mixture thereof. The biodegradable polymer can be poly(ε-caprolactone) (PCL) MW 80,000.

The biodegradable polymer can be in an amount of 20% to 60% by weight, 30% to 50% by weight, 35% to 45% by weight, 32% to 45% by weight, 35% to 60% by weight, 33% to 49% by weight, 30% to 40% by weight, 35% to 45% by weight, or 36% to 57% by weight. The biodegradable polymer can be in an amount of about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, or 60% by weight (wt %). The biodegradable polymer can be in an amount of about 40% by weight.

### Biodegradable Polyol

The biodegradable thermoplastic material described herein can comprise a biodegradable polyol. The biodegradable polyol can be potato starch, wheat starch, chitosan, rice starch, Arrowroot starch, corn starch, optionally corn starch comprising about 20% amylose by weight, Hylon® VII (unmodified corn start comprising about 70% amylose by weight), erythritol, hydrogenated starch hydrolysates, isomalt, lactitol, maltitol, mannitol, sorbitol, xylitol, or a combination thereof. The biodegradable polyol can be corn (maize) starch.

The biodegradable polyol can be in an amount of 1% to 30% by weight, 10% to 20% by weight, 15% to 27% by weight, 12% to 25% by weight, or 15% to 30% by weight, 13% to 29% by weight, 14% to 22% by weight, 15% to 25% by weight, or 16% to 27% by weight. The biodegradable polyol can be in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30% by weight. The biodegradable polyol can be in an amount of about 20% by weight.

### Filler

The biodegradable thermoplastic material described herein can comprise a filler. The filler can be carboxymethyl cellulose, hydroxyethyl cellulose, chitosan, cellulose acetate, cellulose acetate propionate, hydroxypropyl methyl cellulose, hydroxypropyl cellulose, methyl cellulose, microcrystalline cellulose (MCC), or a combination thereof. The filler can be cellulose acetate propionate, hydroxypropyl methyl cellulose, hydroxypropyl cellulose, methyl cellulose, microcrystalline cellulose (MCC), or a combination thereof. The filler can be microcrystalline cellulose (MCC).

The filler can be in an amount of 1% to 20% by weight, 1% to 10% by weight, 1% to 17% by weight, 1% to 15% by weight, or 5% to 10% by weight, 3% to 9% by weight, 4% to 12% by weight, 5% to 20% by weight, or 6% to 17% by weight. The filler can be in an amount of about 1%, 2%, 3%, 4%, 5%, 6%, 7%, 8%, 9%, 10%, 11%, 12%, 13%, 14%, 15%, 16%, 17%, 18%, 19%, or 20% by weight. The filler can be in an amount of about 5% by weight.

### Crosslinker

The biodegradable thermoplastic material described herein can comprise a crosslinker (cross-linking agent). The crosslinker can be glutaraldehyde, glyoxal, succinic anhydride, maleic anhydride, boric acid, citric acid, potassium persulphate, hydrogen peroxide, benzoyl peroxide, or a combination thereof. The crosslinker can be maleic anhydride, potassium persulphate, benzoyl peroxide, boric acid, or a combination thereof. The crosslinker can be boric acid.

The crosslinker can be in an amount of 1% to 20% by weight, 1% to 10% by weight, 1% to 17% by weight, 1% to 15% by weight, or 5% to 10% by weight, 3% to 9% by weight, 4% to 12% by weight, 5% to 20% by weight, or 6% to 17% by weight. The crosslinker can be in an amount of about 1%, 2%, 3%, 4%, 5%, 6%, 7%, 8%, 9%, 10%, 11%, 12%, 13%, 14%, 15%, 16%, 17%, 18%, 19%, or 20% by weight. The crosslinker can be in an amount of 5% by weight.

### Plasticizer

The biodegradable thermoplastic material described herein can comprise a plasticizer. The plasticizer can be a melting temperature modifier. The plasticizer can be a lubricant.

The plasticizer can be triethyl citrate, tributyl citrate, tribuytl acetyl citrate, triacetin, carboxylic acids, optionally C₆-C₁₈ carboxylic acids, dodecanoic acid, stearic acid, behenic acid, castor oil, behenic acid, adipic acid, dodecanol, or a combination thereof. The carboxylic acid can be acetic acid, lactic acid, citric acid, succinic acid, ascorbic acid, or a combination thereof. The plasticizer can be triethyl citrate.

The plasticizer can be in an amount of 1% to 10% by weight, 3% to 10% by weight, 4% to 7% by weight, 5% to 8% by weight, or 6% to 7% by weight, 13% to 20% by weight, 4% to 17% by weight, 5% to 20% by weight, or 6% to 17% by weight. The plasticizer can be in an amount of about 1%, 2%, 3%, 4%, 5%, 6%, 7%, 8%, 9%, 10%, 11%, 12%, 13%, 14%, 15%, 16%, 17%, 18%, 19%, or 20% by weight. The plasticizer can be in an amount of 5% by weight.

The plasticizer can be a lubricant. The lubricant can be triethyl citrate, tributyl citrate, tribuytl acetyl citrate, triacetin, carboxylic acids, optionally C₆-C₁₈ carboxylic acids, dodecanoic acid, stearic acid, behenic acid, castor oil, behenic acid, adipic acid, dodecanol, or a combination thereof. The lubricant can be triethyl citrate.

The lubricant can be in an amount of 1% to 10% by weight, 3% to 10% by weight, 4% to 7% by weight, 5% to 8% by weight, or 6% to 7% by weight, 13% to 20% by weight, 4% to 17% by weight, 5% to 20% by weight, or 6% to 17% by weight. The lubricant can be in an amount of about 1%, 2%, 3%, 4%, 5%, 6%, 7%, 8%, 9%, 10%, 11%, 12%, 13%, 14%, 15%, 16%, 17%, 18%, 19%, or 20% by weight. The lubricant can be in an amount of about 5% by weight.

The plasticizer can be a melting temperature modifier. The melting temperature modifier can be triethyl citrate, tributyl citrate, tribuytl acetyl citrate, triacetin, carboxylic acids, optionally C₆-C₁₈ carboxylic acids, dodecanoic acid, stearic acid, behenic acid, glycerol, or a combination thereof. The carboxylic acid can be acetic acid, lactic acid, citric acid, succinic acid, ascorbic acid, or a combination thereof. The melting temperature modifier can be glycerol.

The melting temperature modifier can be in an amount of 1% to 10% by weight, 3% to 10% by weight, 4% to 7% by weight, 5% to 8% by weight, or 6% to 7% by weight, 13% to 20% by weight, 4% to 17% by weight, 5% to 20% by weight, or 6% to 17% by weight. The melting temperature modifier can be in an amount of about 1%, 2%, 3%, 4%, 5%, 6%, 7%, 8%, 9%, 10%, 11%, 12%, 13%, 14%, 15%, 16%, 17%, 18%, 19%, or 20% by weight. The melting temperature modifier can be in an amount of about 20% by weight.

### Tackifier

The biodegradable thermoplastic material described herein can comprise a tackifier.

The tackifier can be terpene, rosin methyl ester, partially hydrogenated rosin ester, hydrogenated gum rosin alcohol, gum rosin, pentaerythritol gum rosin ester, beeswax, plant oils, or a combination thereof. The tackifier can be pentaerythritol gum rosin ester, for example Eastman Permalyn 6110 Synthetic resin® (pentaerythritol ester of rosin).

The tackifier can be in an amount of 1% to 10% by weight, 3% to 10% by weight, 4% to 7% by weight, 5% to 8% by weight, or 6% to 7% by weight. The tackifier can be in an amount of about 1%, 2%, 3%, 4%, 5%, 6%, 7%, 8%, 9%, or 10% by weight. The tackifier can be in an amount of about 5% by weight.

### Biodegradable Thermoplastic Material

The biodegradable thermoplastic material can comprise (a) 20% to 90% by weight a biodegradable polymer and (b) 3% to 40% by weight a plasticizer, (c) 1% to 20% by weight a crosslinker, wherein the biodegradable thermoplastic material optionally further comprises (d) 10% to 50% by weight a biodegradable polyol; (e) 0% to 20% by weight a filler; (f) 1% and 15% by weight a tackifier, or a combination thereof.

The biodegradable thermoplastic material can comprise (a) 20% to 90% by weight a biodegradable polymer and (b) 3% to 40% by weight a plasticizer, (c) 1% to 20% by weight a crosslinker, (d) 10% to 50% by weight a biodegradable polyol; (e) 0% to 20% by weight a filler; (f) 1% and 15% by weight a tackifier.

The biodegradable thermoplastic material can comprise about 40% by weight a biodegradable polymer. The biodegradable polymer can be polycaprolactone (PCL) average Mn 80,000. The biodegradable polymer can be polycaprolactone (PCL) average Mn 45,000.

The biodegradable thermoplastic material can comprise about 24% by weight a biodegradable polyol. The biodegradable polyol can be corn (maize) starch.

The biodegradable thermoplastic material can comprise about 5% by weight a filler. The filler can be microcrystalline cellulose (MCC).

The biodegradable thermoplastic material can comprise about 5% by weight a crosslinker. The crosslinker can be boric acid.

The biodegradable thermoplastic material can comprise about 20% by weight a plasticizer, optionally wherein the plasticizer is a melting temperature modifier. The plasticizer can be glycerol. Where the plasticizer is a melting temperature modifier, it can be glycerol.

The biodegradable thermoplastic material can comprise about 3% by weight a plasticizer, optionally wherein the plasticizer is a flow modifier. The plasticizer can be tributyl citrate (TBC). Where the plasticizer is a flow modifier, it can be tributyl citrate (TBC).

The biodegradable thermoplastic material can comprise about 3% by weight a tackifier. The tackifier can be Eastman Permalyn 6110 Synthetic resin® (pentaerythritol ester of rosin).

### Articles of Manufacture

The biodegradable thermoplastic material described herein can be used in a variety of packaging applications. An article of manufacture packaged in the biodegradable thermoplastic material described herein. Non-biodegradable packaging can be substituted for the biodegradable thermoplastic material described herein. The biodegradable thermoplastic material described herein can be used in stretch wrap, e.g., used in packaging goods. The biodegradable thermoplastic material described herein can be used in a number of film applications such as agricultural film, extruded onto paper/cardboard as a liner, or as a stretch wrap for wrapping pallets.

Packaging can comprising the biodegradable thermoplastic material described herein. The packaging comprising the biodegradable thermoplastic material described herein can be plastic packaging, shrink wrap, food storage bags, or a combination thereof. An article of manufacture can be packaged in the biodegradable thermoplastic material described herein.

Further, the biodegradable thermoplastic material described herein is ocean compostable. See, e.g., European EN13432; ATSM standard D5338 ISO 14855.

### Methods of Making

A method for making the biodegradable thermoplastic material described herein can comprise mixing the components: (a) 20% to 50% by weight a biodegradable polymer; (b) 1% to 50% by weight a plasticizer, (c) 5% to 40% by weight a biodegradable polyol; (c) 1% to 20% by weight a filler; (d) 1% to 20% by weight a crosslinker; (e) 1% and 15% by weight a tackifier and extrude to produce the material, optionally molding the material into pellets. The extruder can be a single extruder. The extruder can be a twin extruder. The method can be practiced on an assemblage of mixers and extruders run in parallel and/or in series.

The extruder can be configured to allow the components combine and form the material. The extruder can be configured to vent steam, water, or a combination thereof.

The components can be mixed at a temperature between 60° C. to 200° C. The temperature can be between 180° C. and 200° C., optionally 140° C.

The dwell time in the extruder can be between 1-60 minutes. The dwell time in the extruder can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes.

biodegradable thermoplastic material described herein can made by making a paste and feeding through a twin screw extruder, this is a reactive blend process that activates the crosslinkers.

### EXAMPLES

### Example 1

### Film Formulation

Experiments and formulations described herein relate to the development of a compostable stretch wrapping film technology. Most desirable functional attributes considered during parametrization and feasibility studies include biodegradation (target ocean compostable within 9 months), elongation, tensile strength, UV resistance, water resistance, and usable temperature, for example. Materials selection can be based on biodegradability and toxicity (especially aquatic toxicity) of compounds. Screening can be conducted and optimized using unmodified materials whenever possible to limit processing steps and cost unless the material shows substantial advantages to warrant further investigation.

Film formulation development has been divided into two parts: (1) high-throughput materials selection screening via solution casting (2) twin-screw extrusion of selected formulations from part 1.
(1) Aqueous solution casting has been selected as a method for high-throughput materials screening. However, this method will not allow for hydrophobic material screening (e.g., blendable polymers to meet mechanical properties). Hydrophobic polymers such as PE, PCL, among others, can be screened in part 2. The purpose of aqueous solution casting is to narrow the materials selection and determine a range of optimal percentages for each component.
(2) Twin-screw extrusion (TSE) can be conducted following part 1 based on optimal materials selected. PCL has been identified as the most comparable biodegradable polymer to PE and can be later blended to achieve the necessary mechanical properties. PCL has very good tensile and elongation properties similar to PE.

Stretch-wrap film formulation can be divided into 5 main parts: (1) Bulk material (polysaccharide), (2) Td modifier (plasticizer for bulk material), (3) Copolymer (blendable polymer compatible with bulk material), 4) Plasticizer (plasticizer to tailor melt flow and flexibility), and (5) Tackifier (tack and adhesion).

### Materials Selection

All chemicals purchased from Sigma-Aldrich, Acros Organics, Spectrum Chemicals, Fisher Scientific and used as received.

Bulk materials: Potato starch, Wheat starch, Rice starch, Arrowroot starch, Corn starch, optionally corn start comprising about 20% amylose by weight, Hylon®VII (corn start comprising about 70% amylose by weight), carboxymethyl cellulose (CMC), hydroxyethyl cellulose (HEC), cellulose acetate, chitosan, sodium alginate, carrageenan, and xanthan gum.

Td modifiers (divided into categories): Polyols, Ethylene glycol, Propylene glycol, 1,4-butanediol, Glycerol, and Sorbitol.

Carboxylic acids: Acetic acid, Lactic acid, Citric acid, Succinic acid, Ascorbic acid, and Triethyl citrate.

Sugars: Glucose, Fructose, Sucrose, and Maltodextrin.

Amines: Urea, Ethanolamine, Taurine, and Betaine.

Low Molecular Weight (MW) polymers: Polyethylene glycol (PEG) 400; polyethylene glycol (PEG) 1500; and Polyvinyl alcohol (PVA) MW: 13K.

Copolymers: Polyvinyl alcohol (PVA) MW: 85K and 146K; Polyhydroxybutyrate (PHB); polylactic acid (PLA); and Poly(ε-caprolactone) (PCL) MW: 80K.
Plasticizers: Stearic acid, Castor oil, Behenic acid, Adipic acid, and Dodecanol.
Tackifiers: Rosin esters, Terpenes, Glycerol monoleate, Beeswax, and Plant oils.

### Preliminary Experiments

### Aqueous Solution Casting

Oven dry starch at 65° C. overnight. Mix 70% starch/30% Td and at various solids content (2-10% w/v in DI water) to optimize casting viscosity to yield thin film. Heat to above gel temperature (60-80° C.) under constant stirring. Cast into glass petri dish. Air-dry and oven dry for various times and temperatures to determine preferred conditions.

The 70/30 mixture was used based on preliminary research. increasing solids content to 10% leads to extremely viscous solutions and entrained air during mixing leading to film defects. Centrifugation, speed mixing, or degassing over time can lead to air removal. Sonification was not very effective. Preferred solids content for various starches was between 4-7%. No noticeable visual differences between starch films. Starch films are highly moisture sensitive. Fast oven drying can lead to solidification of top layer leading to cracks as bottom layer dries. PVA, a highly biodegradable and water-soluble polymer was used as a place holder for PCL to cast films during preliminary screening.

### 60/20/20 w/w Bulk Matl/Td Mod/PVA 85K Screening

This procedure was developed to quickly screen various Td modifiers for each bulk material
1. Solubilize PVA in deionized (DI) water at >95° C. and cool to RT—5% w/v PVA;
2. Disperse starch in DI water at RT (25° C.)—7% w/v starch;
3. Add Td modifier to starch//water mixture;
4. Add solubilized PVA to mixture;
5. Heat to 90° C. for 5 minutes (min), remove from heat and cool to 60° C.;
6. Pout gelatinized mixture into petri dish ˜20-40 mL;
7. Use glass rod to remove air bubbles by skimming top surface towards edges; and
8. Air-dry overnight before peeling

Procedure was adapted for various bulk materials. CMC, HEC, chitosan, alginate, and carrageenan solubilized in 1-2 wt % using dispersion blade at RT (25° C.). Chitosan solubilization needs acid at >1%. AcOH was used to solubilize chitosan.

### Organic Solution Casting of PCL

Procedure was adapted from Sarasam A, Madihally S.—Characterization of chitosan-polycaprolactone blends for tissue engineering applications.

Notes: no suitable solvent system was developed for solution casting PCL to form uniform thin films. All led to phase separation/precipitation of PCL.

### Crosslinking Studies

Succinic acid, glyoxal, glutaraldehyde and synthesized oxidized-sucrose were studied as potential crosslinkers. Similar procedure was adapted from the 60/20/20 screening using crosslinker at a concentration of 1-10 wt %. These studies were conducted without PVA with composition of 70% starch, 30% Td modifier. Triethylamine was used as catalyst for succinic acid and oxidized sucrose screening.

No significant advantages from succinic and oxidized-sucrose crosslinking. Glyoxal modified films tended to become brittle overtime. Glutaraldehyde was very effective at increasing tensile strength, elongation, and moisture sensitivity. High glutaraldehyde concentration led to brittleness over time potential caused by further crosslinking over time due to excess glutaraldehyde. Preferred glutaraldehyde concentration is <1% for corn starch.

### Hylon® VII Screening

Hylon® VII requires increased processing temperature. It has better flow and the optimal hydration was 10 wt % with a 10 mL casting solution into the petri dish. The procedure was adapted from the 60/20/20 screening. To reach the required gelation temperature, a pressure flask was heated under constant stirring in an oil bath heated to 150° C. for 30 min. The mixture was then cooled to before uncapping and casting solution into petri dish.

### Corn Starch Td Optimization

60/40, 70/30, 80/20, 90/10 starch:Td modifier was screened to determine optimal Td modifier content. 70/30 was found to be preferred, exhibiting decent moisture sensitivity while maintaining mechanical properties. 90/10 tended to be brittle with poor moisture sensitivity while led to poor film formation, cohesion, or blooming of Td modifier.

### Td Blends

Td modifier blends were screened to observe interactions between various Td modifiers to develop a more complex formulation. 70/30 was employed with Td modifier concentrations varied from 20/5. 15/10, 10/15, 5/20 wt % of Td modifier 1 to Td modifier 2. Glycerol which was found to be the preferred Td modifier for corn starch was held constant varying Td modifier 2 from the list of above. The preferred ratio was found to be between 1:1 and 2:1 glycerol:sorbitol. Urea, ethanolamine, lactic acid, and betaine were also very effective at improving moisture sensitivity and elongation properties.

Bulk material blends—50/10/30 wt % starch/bulk matl/glycerol

Starch compatibility with alginate, CMC, xanthan gum, and chitosan were assessed. At 10%, CMC and alginate showed poor compatibility and cohesion. CMC showed some elongation and may have potential for further testing. Alginate seemed to be worse than CMC and had poor peelability. Xanthan gum was a possible candidate but no advantage over chitosan was observed. Chitosan showed good compatibility and was further screened at ratios of 1:3, 1:1, and 3:1 starch to chitosan. Increased clarity and opacifying properties of chitosan were observed at increasing concentration along with better moisture sensitivity at high chitosan loading.

### Results

Based on the preliminary screening, Hylon® VII and chitosan were found to be the most preferred bulk materials. Chitosan was shown to exhibit static and self-adhesion properties along with other amines which could be a result of charge carrying ability of amines and free lone pair electrons. Preliminary screening shows poor compatibility with starch in comparison to chitosan. The best combination for starch was found to be ˜15-30 wt % on basis of starch of glycerol, sorbitol, urea, betaine, lactic acid, or some combination with glycerol. Glycerol should be a main component due to cross compatibility with other bulk materials and should be used at a ratio of 1:1 or greater with a secondary Td modifier. Glutaraldehyde should be <1% which should be completely consumed resulting in no toxicity and no significant difference in biodegradation.

Bulk materials selection: CMC and alginate show good film forming abilities and compatibility with PVA. However, when cast without PVA, they tend to be brittle. Similar Td modifier observations were seen when compared to chitosan and starch. HEC was extremely brittle and carrageenan produced gels rather than film.

Chitosan has very good film forming ability while also providing the opportunity for many different functional chemistries due to the amines present on the backbone and has been selected for further screening. Preliminary screening also shows good compatibility with starch in comparison to other bulk materials.

Starch is the main bulk material of interest based on the amount of research already conducted by previous institutions and mainly for cost. However, it has poor functional properties such as moisture sensitivity and brittleness which no solution has been found. Corn starch exhibited preferred properties.

### Main Reasons for Td Modifier Failure

Ethylene glycol—brittleness, potential to be used at <5% when blended with glycerol

Propylene glycol—brittleness, potential to be used at <5% when blended with glycerol

1,4-butanediol—whitening, poor compatibility with starch, potential to be used with chitosan

Acetic acid—mainly used a dissolution aid for chitosan

Citric acid—leads to brittleness at high concentrations, does not show advantages in comparison to other crosslinking aids like glutaraldehyde and is also less effective

Succinic acid—no advantages over citric acid and glutaraldehyde crosslinkers

Ascorbic acid—no film formation

Triethyl citrate—blooming, potential as plasticizer

Glucose—leads to brittleness and browning (potential sugar caramelization at high temperatures)

Fructose—same as glucose

Sucrose—same as other sugars but even less effective at improving flexibility, moisture sensitivity

Maltodextrin—poor film formation.

Ethanolamine—promising Td modifier but it is an aquatic hazard that would potentially leach out upon degradation, provides good moisture sensitivity and flexibility

Taurine—strong, flexible, elongating film but appears to bloom, crystallize, or precipitate out over time leading to film whitening, potential to be used at lower concentration.

Low MW polymers—all led to extreme brittleness and did not provide significant benefits as compatibilizer between starch and PVA.

All the Td modifiers above mainly failed due to brittleness and poor moisture sensitivity overtime with the exception of ethanolamine and taurine. Many also failed because they showed no elongation potential without being chemically modified.

### Example 2

### Td Modifier Concentration Testing

Starch Td optimization: To determine the optimal Td modifier concentration for the selected materials. The selected materials provide the best moisture sensitivity, film forming ability, and flexibility: Glycerol, Sorbitol, Urea, and Betaine.

### Procedure

1. 0.5 g samples cast with the following weight ratios of starch to Td: 80/20, 70/30, 60/40 (90/10 was not screened because it can be too brittle)
2. Prepare 2 wt % solution of starch and mix samples.
3. Heat samples under constant stirring to 80° C. for 5 min
4. Cast solution (˜20 mL) onto glass petri dish and air-dry overnight before peeling
5. Samples left to equilibrate at RT over a few days to observe retrogradation and brittleness
Note: RH is roughly 15-25%. ˜0.2 g of starch/sample.

Glycerol is effective across whole range 80/20-60/40. Increased Td content leads to softer more flexible films at the expense of strength.

Sorbitol is most effective at 70/30. 80/20 led to brittleness while 60/40 led to poor film formation and cohesion. Urea is most effective between 80/20-70/30. 60/40 led to apparent blooming and whitening of film. Film was very sticky and balls up on itself. Betaine is most effective at 70/30. 60/40 led to slight blooming and whitening but not nearly to the extent of urea. Possible that the compound is crystallizing/precipitating out over time.

### Chitosan Td Testing

The selected materials provide the best moisture sensitivity, film forming ability, and flexibility: Glycerol, Urea, and Betaine.

Procedure: Adapted from previous experiment. Only changes include using a 1% acetic acid or lactic acid solution for dissolution of chitosan. Note: ˜0.5 g of chitosan/sample. Sorbitol has been omitted even though it shows good compatibility with starch but leads to brittleness of chitosan.

Sorbitol is more effective as a co-modifier with glycerol especially in starch at a ratio of >1:1 starch:Td. Lactic acid is superior to acetic acid dissolution as it yields less viscous solutions and provides greater elongation properties.

Glycerol is effective across the whole range of concentrations assessed from 80/20-60/40. Increased Td leads to softer more flexible films at the expense of strength. Sorbitol is most effective at 70/30. 80/20 led to brittleness and 60/40 led to poor film formation. Urea is most effective between 80/20-70/30. 80/20 yielded acceptable film while 70/30 led to some partial crystallization of urea. 60/40 led to increased crystallization which led to embrittlement Betaine acts similarly to urea. It is most effective at 80/20. 70/30 led to partial crystallization and 60/40 led to significant crystallization leading to film whitening and embrittlement Note: All films above were dissolved in AcOH. films dried in oven at 65° C. led to embrittlement.

### Starch/Chitosan Testing

To determine the best combination of Td modifiers. The ratio between polysaccharide bulk material Td modifier can be fixed at 70/30 wt % based on the results from individual screening of starch and chitosan. Starch:chitosan ratio can be fixed at 65/35 wt %. Td modifier combinations can be screened at a 1:1:1 ratio for all combinations of the following materials selected based on previous experiments: Glycerol, Sorbitol, Urea, Betaine, and Lactic acid

### Td Modifier Combinations

(Glycerol, Sorbitol, Urea)
(Glycerol, Sorbitol, Betaine)
(Glycerol, Sorbitol, Lactic acid)
(Glycerol, Urea, Betaine)
(Glycerol, Urea, Lactic acid)
(Glycerol, Betaine, Lactic acid)
(Sorbitol, Urea, Betaine)
(Sorbitol, Urea, Lactic acid)
(Sorbitol, Betaine, Lactic acid)
(Urea, Betaine, Lactic acid)
1. Prepare ˜2 wt % solution of chitosan in 1% lactic acid(aq) using dispersion blade—1.5 g/75 mL
2. Prepare ˜5 wt % solution of Hylon VII—2.78 g/50 mL;
3. Mix chitosan solution with Hylon VII solution in a pressure flask and heat to 150° C. under constant stirring;
4. Cool to 90° C. before relieving pressure;
5. In a separate beaker, mix 0.35 g of solution (˜10.2 mL) with 0.15 g of Td modifier and heat to for 5 min;
6. and cast into a petri dish; and
7. Allow to dry at RT overnight (RH ˜30%)

### Results

Glycerol yielded good film cohesion overall. Sorbitol led to brittle films—only certain sections could be peeled. Urea yielded good film cohesion when paired with glycerol or lactic acid. Betaine yielded very poor films—poor cohesion and brittleness. Lactic acid seems effective when paired with glycerol or urea. Overall, sorbitol was ineffective unless paired with glycerol which was expected. Ratio should most likely be between 2:1 and 1:1 glycerol:sorbitol. Betaine appears to be less effective than urea. Ratios to be optimized most likely for success are glycerol:urea:lactic acid. Glycerol could be replaced by a ˜1.5-2:1 of glycerol:sorbitol. Films yielding best results from best to worst are as follows: 123/125, 135, 145, 235. Note: Film casting of 0.5 g solids is too low. Increase to 1 g. 0.5 g lead to portions with porosity due to there not being enough material to cover the bottom of the petri dish.

### Low MW CS—Tidal Vision

To screen film forming ability of low MW chitosan supplied by Tidal Vision.
1. Prepare 2 wt % solution of CS in 10% lactic acid (aq);
2. Mix using dispersion blade until completely solubilized ˜2 hours—should be semi-translucent yellowish solution;
3. Add enough Hylon® VII in a 2:1 ratio of Hylon® VII:CS and add additional DI water to reach a 5 wt % solution;
4. In a pressure vessel under constant stirring, hear to 150° C. for ˜30 min.;
5. Cool to 90° C. before uncapping;
6. In separate beakers, mix the corresponding ratios of glycerol and urea for each sample and heat to 90° C. for 5 minutes (min.);
7. Cast 30 mL of each solution into a petri dish; and
8. Dry overnight at RT (25° C.).

TABLE 1

| Hylon | CS | Lactic | Glycerol | Urea | Total |
|---|---|---|---|---|---|
| VII (g) | (g) | acid (g) | (g) | (g) | (g) |
| 1 | 0.5 | 0.25 | 0.25 | 0.25 | 2.25 |
| 1 | 0.5 | 0.25 | 0.33 | 0.17 | 2.25 |
| 1 | 0.5 | 0.25 | 0.375 | 0.125 | 2.25 |
| 1 | 0.5 | 0.25 | 0.25 | 0.1 | 2.1 |
| 1 | 0.5 | 0.25 | 0.35 | 0 | 2.1 |
| 1 | 0.5 | 0.25 | 0.25 | 0 | 2.0 |

Note: RH ˜25%. Chitosan (CS) and Hylon® VII (H7). Ratio of H7:CS held constant at 2:1. Lactic acid content held constant at ˜16% on basis of total bulk material (H7+CS). Total Td content held at 40/50% on basis on total bulk.

Example 3

### Td Modifier

### Background

Experiments and formulations described herein are an extension prior experiments. Specifically, part 2, TSE extrusion based on the selected materials from part 1. All percentages listed are the percentage of solids by weight.

### Total Td Modifier Content Testing

In the first set of experiments, the total Td modifier percentage were determined. The breakdown of percentages is below:
30% Polycaprolactone (PCL)
10% Triethyl citrate (TEC)
60% Bulk material/Td modifier

The ratio of bulk material to Td modifier can be varied to determine the optimal Td modifier content. The bulk material ratio can be fixed at 65:35 Hylon VII (H7):CS. First screening can be conducted with glycerol as Td. 20 g batches can be extruded.

TABLE 2

| | | | | | Bulk | | Bulk | | Td | |
|---|---|---|---|---|---|---|---|---|---|---|
| | Copolymer | | Plasticizer | | Material | | Material | | Modifier | |
| Exp | (PCL) | | (TEC) | | (H7) | | (CS) | | (glycerol) | |
| 1 | 31.5% | (6 g) | 10.5% | (2 g) | 34.2% | (6.5 g) | 18.4% | (3.5 g) | 5.3% | (1 g) |
| 2 | 33.3% | (6 g) | 11.1% | (2 g) | 28.9% | (5.2 g) | 15.6% | (2.8 g) | 11.1% | (2 g) |
| 3 | 35.3% | (6 g) | 11.8% | (2 g) | 22.9% | (3.9 g) | 12.4% | (2.1 g) | 17.6% | (3 g) |
| 4 | 42.9% | (6 g) | 14.3% | (2 g) | 9.3% | (1.3 g) | 5.0% | (0.7 g) | 28.6% | (4 g) |
| 6 | 30% | (6 g) | 10% | (2 g) | 13% | (2.6 g) | 7.0% | (1.4 g) | 40% | (8 g) |
| 7 | 30% | (6 g) | 10% | (2 g) | 19.5% | (3.9 g) | 10.5% | (2.1 g) | 30% | (6 g) |
| 8 | 30% | (6 g) | 10% | (2 g | 26% | (5.2 g) | 14.0% | (2.8 g) | 20% | (4 g) |
| 9 | 30% | (6 g) | 10% | (2 g) | 32.5% | (6.5 g) | 17.5% | (3.5 g) | 10% | (2 g) |
| 10 | 30% | (6 g) | 10% | (2 g) | 13% | (2.6 g) | 7.0% | (1.4 g) | 40% | (8 g) |

1. Set barrel temperature zone 1-3 to 140° C. and screw speed to 250 rpm;
2. Batch mix and slowly load through hopper;
3. Mix until screw torque levels before extruding; and
4. Cut 4 inch (in.) sample and measure elongation.
Results: Elongation at break (4 in sample)
601-1: 0%
601-2: 0%
601-3: 0%
601-4: 200% (12in)
601-6: n/a
601-7: 262% (14.5in)
601-8: 225% (13.0in)
601-9: 0%
601-10: 275% (15.0in)

Notes: Screw torque appears linear with Td modifier content. 601-10˜1500N, 601-07˜2000N, 601-8˜2500N, 601-9˜3000N. Optimal Td content between 30-40%. 50% too high? Appears that matrix is absorbing glycerol? No blooming visible, slightly greasy/oily surface but nothing concerning.

### Chitosan/Lactic acid Testing

To determine optimal lactic acid concentration for system without Hylon®VII. The breakdown of percentages is below:
30% PCL
10% TEC
60% CS/Td modifier

The ratio of CS:glycerol will first be tested followed by addition of lactic acid.

TABLE 3

| EXP | PCL | TEC | CS | Glycerol | | Lactic Acid |
|---|---|---|---|---|---|---|
| a1 | 30% (6 g) | 10% (2 g) | 30% (6 g) | 30% | (6 g) | 0% |
| a2 | 30% (6 g) | 10% (2 g) | 20% (4 g) | 40% | (8 g) | 0% |
| a3 | 30% (6 g) | 10% (2 g) | 10% (2 g) | 50% | (10 g) | 0% |
| a4 | 30% (6 g) | 10% (2 g) | 30% (6 g) | 25% | (5 g) | 5% (1 g) |

1. Set barrel temperature zone 1-3 to 110° C. and screw speed to 250 rpm Results

Poor mixing observed when extruded at 110° C. Small tears in sample coming out. Very poor elongation if any. Temperature increased to 140° C. and mixing time of 5 minutes. Samples came out with smoother surface but no elongation. 601-a3 clogged extruder. Glycerol loading may be too high. Crosslinking? 601-a2˜40% elongation. Very poor strength.

### Chitosan Td Testing

To determine Td loading at fixed concentration of PCL and TEC, 30% and 10% respectively.

TABLE 4

| Exp | PCL | CS | Glycerol | TEC |
|---|---|---|---|---|
| b1 | 30% | 50% | 10% | 10% |
| b2 | 30% | 40% | 20% | 10% |
| b3 | 30% | 30% | 30% | 10% |
| b4 | 30% | 20% | 40% | 10% |

### Protocol

1. Set barrel temperature zone 1-3 to 140° C. and screw speed to 250 rpm
2. Batch mix 20 g of sample and load into compounder
3. Collect ˜6″ samples

### Results

601-b1 very dry, extrudes very slowly. Subsequent samples run and eventually plugged die. May need to find minimum liquids content for extrusion. Start by extruding high liquids samples first to avoid plugging die.

### Hylon ®VII Testing

To determine the optimal Td loading for Hylon® VII at fixed concentration of PCL and TEC, 30% and 10% respectively.

TABLE 5

| EXP | PCL | H7/Td | Glycerol | TEC | Elongation |
|---|---|---|---|---|---|
| c0 | 30% | 20% | 40% | 10% | Liquid/runny |
| c1 | 30% | 30% | 30% | 10% | 15.75″, 17″, 18.75″-329% |
| c2 | 30% | 40% | 20% | 10% | 15″-275% |
| c3 | 30% | 50% | 10% | 10% | 12.5″-15″-244% |
| c4 | 30% | 30% | 30% | 10% | 13.5″-14″-244% |
| c5 | 30% | 40% | 20% | 10% | 15″-275% |
| c6 | 30% | 30/10% urea | 20% | 10% | 15″-17.75″-309% |
| c7 | 30% | 20/20% urea | 20% | 10% | 12.5″-13″-219% |
| c8 | 30% | 30/10% sorbitol | 20% | 10% | 12.25″-13%-213% |
| c9 | 30% | 20/20% sorbitol | 20% | 10% | 13″-14.75″ |
| c10 | 30% | 30/10% ethylene glycol | 20% | 10% | 10.5″-12.25″ |
| c11 | 30% | 20/20% ethylene glycol | 20% | 10% | 11″-12″ |

### Results

601-c1: rough outer surface, dark grey
601-c2: smooth outer surface, lighter grey
601-c3: smooth, even lighter grey, some fail to pull or pull less—12.5-15″
601-c4: beige color, grey from compounder or hopper?
601-c5: similar to c4 but lighter
601-c6: yellowish
601-c7: yellowish fibrous sample
601-c8: yellowish fibrous sample
601-c9: grey/yellowish fibrous sample
601-c10: soft, weak, grayish sample
601-c11: gray fibrous sample

TABLE 6

| EXP | PCL | H7/Td/CS | Glycerol | TEC | Elongation |
|---|---|---|---|---|---|
| d1 | 30% | 30/10% urea | 20% | 10% | 15.75″, 18″, 19″-340% |
| d2 | 30% | 30/10 betaine | 20% | 10% | 15.25″, 16.5″, 17″-306% |
| d3 | 30% | 20/20% betaine | 20% | 10% | 15″-275% |
| d4 | 30% | 25/10/5% urea | 20% | 10% | 15.75″, 17.25″, 18″-325% |
| d5 | 30% | 20/10/10% urea | 20% | 10% | 14.25″, 15.5″, 17.25″-292% |
| d6 | 30% | 15/10/15% urea | 20% | 10% | 13.5″-238% |

### Results

601-d1: light gray, fibrous
601-d2: lighter beige, fibrous, slightly softer
601-d3: increased yellowing, spongy, softer, less tensile?
601-d4: yellow, increased strength
601:d5: spongy, less fibrous
601-d6: even spongier, slightly darker

Filler/reinforcement testing: To find viable filler/reinforcement aids to increase tensile strength and water sensitivity without significantly compromising elongation. Barrel temperature and screw speed were fixed at 140° C./250 rpm. The concentration of PCL, Glycerol, Urea, and TEC were fixed at 30%, 20%, 10%, 10% respectively.

TABLE 7

| EXP | H7 | Filler | Elongation |
|---|---|---|---|
| e0 | 30% | 0% | 16.5″-17″-319% |
| e1 | 25% | 5% cellulose acetate | 13.5″-15″-256% |
| e2 | 20% | 10% cellulose acetate | <10% |
| e3 | 25% | 5% HEC | 14.25″-15.75″-275% |
| e4 | 20% | 10% HEC | 16.5″-16.75″-316% |
| e5 | 25% | 5% CMC 90K | 16.75″-17.25″-325% |
| e6 | 20% | 10% CMC 90K | <50% |
| e7 | 25% | 5% CMC 700K | 16″-300% |
| e8 | 20% | 10% CMC 700K | <50% |
| e9 | 25% | 5% xanthan gum | 15.75″-294% |
| e10 | 20% | 10% xanthan gum | <10% |
| e11 | 25% | 5% alginic acid | <10% |

Results: Most show poorer cohesion and elongation at 10% loading with the exception of HEC. Conglomeration within TPS matrix at high filler loading results in diminished mechanical properties.
601-e1: hard, fibrous, comparable strength to 601-e0
601-e2: whitening effect by filler, poor elongation
601-e3: spongy white during fiber pull-out, decreased strength in comparison to e0 and el
601-e4: smooth surface very good strength
601-e5: browning by filler, relatively smooth surface and good strength
601-e6: appears to have aggregation of CMC along fiber
601-e7: similar to e6, rough/semi-bubbled surface, poor mixing
601-e8: similar to e7, spongier during elongation, cannot be pulled as thin, poor mixing
601-e9: bubbled and clumping of gum, similar to e6-8, poor mixing, inconsistent elongation
601-e10: similar to e9
601-e11: lighter yellow-brown color than e6-9 similar to e4

TABLE 8

| EXP | PCL/LLDPE | H7 | TEC/AP | Glycerol | Urea | Filler | Elongation |
|---|---|---|---|---|---|---|---|
| f1 | 0/30% | 40% | 10% | 20% | 0% | 0% | |
| f2 | 30% | 30% | 10% | 30% | 0% | 0% | 16.75″ |
| | | | | | | | 17.75″ |
| f3 | 30% | 25% | 10% | 20% | 10% | 10% | 17.75″ |
| | | | | | | | 18″ |
| f4 | 30% | 20% | 10% | 20% | 10% | 10% | 17.75″ |
| | | | | | | | 18.5″ |
| f5 | 30% | 25% | 10% | 20% | 10% | 10% | 15″ |
| f6 | 30% | 20% | 10% | 20% | 10% | 10% | 11″ |
| f7 | 30% | 30% | 5/5% | 20% | 10% | 10% | <10% |
| f8 | 30% | 30% | 0/10% | 20% | 10% | 10% | 19.25″ |
| | | | | | | | 19″ |

Results: Ascorbyl palmitate (AP. Microcrystalline cellulose (MC). F5, F6 PVA require higher processing temperature. PVA Tm ˜200° C. Concern of processing at high temperatures >140° C. due to volatilization of urea.

### Summary Table

TABLE 9

| EXP | PCL | H7 | TEC | Glycerol | Td | Filler | Elongation |
|---|---|---|---|---|---|---|---|
| c1 | 30% | 30% | 10% | 30% | 0% | 0% | 329% |
| c6 | 30% | 30% | 10% | 20% | 10% | 0% | 309% |
| | | | | | urea | | |
| d1 | 30% | 30% | 10% | 20% | 10% | 0% | 340% |
| | | | | | urea | | |
| e0 | 30% | 30% | 10% | 20% | 10% | 0% | 319% |
| | | | | | urea | | |
| d2 | 30% | 30% | 10% | 20% | 10% | 0% | 306% |
| | | | | | betaine | | |
| d4 | 30% | 25% | 10% | 20% | 10% | 5% | 325% |
| | | | | | urea | chitosan | |
| e4 | 30% | 20% | 10% | 20% | 10% | 10% | 316% |
| | | | | | urea | HEC | |
| e5 | 30% | 25% | 10% | 20% | 10% | 5% | 325% |
| | | | | | urea | CMC 90K | |
| e7 | 30% | 25% | 10% | 20% | 10% | 5% | 300% |
| | | | | | urea | CMC 700K | |

TABLE 10

| | Minimum elongation | |
|---|---|---|
| EXP | (4″ initial length) | Maximum Elongation |
| c1 | 15.75″-294% | 18.75″-369% |
| c6 | 15″-275% | 17.75″-344% |
| d1 | 15.75″-294% | 19″-375% |
| e0 | 16.5″-313% | 17″-325% |
| d2 | 15.25″-281% | 17″-325% |
| d4 | 15.75″-294% | 18″-350% |
| e4 | 16.5″-313% | 16.75″-319% |
| e5 | 16.75″-319% | 17.25″-331% |
| e7 | <50% | 16″ |

TABLE 11
TGA data

| EXP | Td1 (C) | Mass Change (%) | Td2 (C) | Mass change (%) |
|---|---|---|---|---|
| c1 | 180 | 53.38 | 360 | 31.17 |
| d2 | 220 | 52.26 | 360 | 30.91 |
| d4 | 200 | 44.20 | 370 | 34.45 |
| e0 | 200 | 49.99 | 370 | 33.26 |
| e4 | 210 | 44.43 | 370 | 29.80 |
| e5 | 220 | 45.93 | 360 | 29.33 |
| e7 | 220 | 37.02 | 360 | 42.76 |
| Hylon VII | 310 | 68.59 | | |
| PCL | 360 | 87.65 | | |
| Chitosan | | | | |
| CMC 90K | | | | |
| CMC 700K | 290 | | | |
| HEC 90K | 300 | | | |
| Urea | 180 | | 350 | |

Results: TG data correlates with decomposition of Td modifiers and plasticizers which is 40 wt % for all samples tested. At second decomposition event is seen at temperatures >350 of PCL, H7, and filler. CMC 90K and Chitosan show increasing mass over time and TGA can be run again. Concerns over urea decomposition after its melt temp or 135C can be further tested. Urea may form ammonia gas along with other condensed ureas (biuret, triuret, cyanuric acid, etc.) between processing temperatures of 135-200° C. which could introduce defects and air bubbles

Potential substitutes to urea with similar structure
trimethyl glycine (TMG)=betaine
choline/choline chloride
homocysteine
ascorbic acid

### Formulation

Bulk material (50-60%)
30% PCL
20-30% H7
Td modifier (30-40%)
20-30% Glycerol
10% Urea/Betaine
Plasticizer (5-10%)
TEC
AP
Lactic acid
Reinforcement/filler/copolymer (1-10%)
MC
CMC 90K
HEC 90K
PVA 85K
Tackifier (5-10%)
Staybelite Resin E—partially hydrogenated gum rosin—price incentive but no antioxidant
Abalyn DE—monohydric alcohol from hydrogenated rosin acid—hydrogenated gum rosin alcohol
Permalyn 6110M—gum rosin
Low MW chitosan

TABLE 12

| EXP | PCL | H7 | Glycerol | Td | Plasticizer | Elongation |
|---|---|---|---|---|---|---|
| g0 | 30 | 35 | 30 | | 5 AP | 12″ |
| g1 | 30 | 30 | 30 | | 5/5 AP/TEC | 9.25″ |
| g2 | 30 | 30 | 30 | | 5/5 AP/BDO | 15.75″ |
| g3 | 27 | 36 | 27 | | 9 BDO | 13″ |
| g4 | 30 | 40 | 20 | | 10 TEC | 19″ |
| g5 | 30 | 35 | 20 | 5 LA | 10 TEC | 14″ |
| g6 | 30 | 30/5 | 20 | 5 LA | 10 TEC | 13.5″ |
| | | CS | | | | |
| g7 | 30 | 25/10 | 20 | 5 LA | 10 TEC | <50% |
| | | CS | | | | |
| g8 | 30 | 35/5 | 20 | | 10 TEC | <50% |
| | | LMW CS | | | | |

TABLE 13

| EXP | PCL | H7 | Glycerol | TEC | Tackifier | Elongation |
|---|---|---|---|---|---|---|
| h1 | 30 | 40 | 20 | 5 | 5 Staybelite | <50% |
| h2 | 30 | 35 | 20 | 10 | 5 Staybelite | <50% |
| h3 | 30 | 30 | 20 | 15 | 5 Staybelite | 14.5″ |
| h4 | 30 | 40 | 20 | 5 | 5 Abalyn | 13.5″ |
| h5 | 30 | 35 | 20 | 10 | 5 Abalyn | 16.5″ |
| h6 | 30 | 30 | 20 | 10 | 10 Abalyn | 14″ |
| h7 | 30 | 30/5 | 20 | 10 | 5 Abalyn | |
| | | MC | | | | |
| h8 | 30 | 30/5 | 20 | 10 | 5 Abalyn | |
| | | CS | | | | |

### Example 4

### Stretch-Film Crosslinking Study

Continuation experiments described herein. The preferred baseline formulation was selected based on a cast-film extrusion trial. The formulation is below:

TABLE 14

| Bulk | Bulk | Td Modifier | Plasticizer | Tackifier | Filler |
|---|---|---|---|---|---|
| PCL 30% | H7 30% | Glycerol 20% | TEC 10% | Abalyn 5% | MC 5% |

Note: Preliminary plasticizer study results below:

Formulation: 26% Corn starch, 11% ethylene glycol, 38% PCL, 25% plasticizer

TABLE 14

| | Qualitative | Approx. | Visible Phase |
|---|---|---|---|
| Plasticizer | Melt Flow | Elongation | Separation |
| N/A | Moderate | 20% | No |
| TEC | High | 40% | No |
| Castor Oil | Moderate | 125% | No |
| Behenic Acid (C22) | Very High | <10% | No |
| Stearic Acid (C18) | Very High | <10% | No |
| Adipic Acid (C6) | Very High | <10% | No |
| Dodecanol (C12) | Very High | <10% | No |

Formulation: 25% Chitosan, 8% Glycerol, 42% PCL, 25% Plasticizer

TABLE 15

| | Qualitative | Approx. | Visible Phase |
|---|---|---|---|
| Plasticizer | Melt Flow | Elongation | Separation |
| None | Very Low | 275% | No |
| 25% TEC | High | 300% | No |
| 10% TEC | Moderate | 250% | No |
| 25% Castor Oil | Very High | N/A | No |
| 10% Castor Oil | Moderate | 225% | No |

Potential identified crosslinking methods: (1) Boric acid crosslinking of hydroxyl containing compounds; (2) Hydrogen peroxide oxidation with iron (Fe²⁺) catalyst; and (3) Benzoyl peroxide oxidation with potassium persulfate catalyst.

Boric acid crosslinking trials—percentages listed below

TABLE 16

| | | | | Strength | Boric | Glycerol/ | | |
|---|---|---|---|---|---|---|---|---|
| NO. | PCL | Starch | PVA | Filler | Acid | Co-Td Modifier | TEC | Tackifier |
| 1 | 30 | 25 H7 | 5 | 5 MC | 0.3 | 12 | 6 | 3 Abalyn |
| 2 | 30 | 25 H7 | 5 | 5 MC | 0.5 | 20 | 10 | 5 Abalyn |
| 3 | 30 | 22 H7 | 5 | 5 MC | 3 | 20 | 10 | 5 Abalyn |
| 4 | 40 | 17 H7 | | 5 MC | 3 | 20 | 10 | 5 Abalyn |
| 5 | 40 | 17 H7 | | 5 MC | 3 | 15/5 | 10 | 5 Abalyn |
| | | | | | | adipic acid | | |
| 6 | 40 | 17 H7 | | 5 MC | 3 | 15/5 | 10 | 5 Abalyn |
| | | | | | | butanediol | | |
| 7 | 40 | 17 H7 | | 5 MC | 3 | 15/5 | 10 | 5 Abalyn |
| | | | | | | mannitol | | |
| 8 | 35 | 20 H7 | | 5 MC | 5 | 15/5 | 8 | 5 Abalyn |
| | | | | | | sorbitol | | |
| 9 | 35 | 16 H7 | 6 | 8 MC | 5 | 20 | 10 | 5 Abalyn |
| 10 | 35 | 10 H7 | 10 | 5 MC | 5 | 20 | 10 | 5 Abalyn |
| 11 | 40 | 10 H7 | 5 | 5 MC | 5 | 20 | 10 | 5 Abalyn |
| 12 | 30 | 15 H7 | 10 | 5 MC | 5 | 20 | 10 | 5 Abalyn |
| 13 | 20 | 20 H7 | 15 | 5 MC | 5 | 20 | 10 | 5 Abalyn |
| 14 | 40 | 40 H7 | | | | 10/10 | | |
| | | | | | | piecolic acid | | |
| 15 | 40 | 40 H7 | | | | 10/10 | | |
| | | | | | | proline | | |
| 16 | 40 | 17 H7 | 5 | 5 MC | 3 | 15 | 10 | 5 Abalyn |
| 17 | 40 | 17 H7 | | 5 MC | 3 | 18/2 | 10 | 5 Abalyn |
| | | | | | | Tergitol | | |
| | | | | | | 15-S-40 | | |
| 18 | 40 | 17 H7 | | 5 MC | 3 | 15/5 | 10 | 5 Abalyn |
| | | | | | | proline | | |
| 19 | 40 | 17 H7 | | 5 MC | 3 | 15/5 | 10 | 5 Abalyn |
| | | | | | | glycerol | | |
| | | | | | | monostearate | | |
| 20 | 40 | 17 H7 | | 5 MC | 3 | 20 | 10 | 5 Abalyn |
| 21 | 40 | 7 H7/ | | 5 MC | 3 | 20 | 10 | 5 Abalyn |
| | | 10 Corn | | | | | | |
| 22 | 40 | 17 Corn | | 5 MC | 5 | 20 | 8 | 5 Abalyn |
| 23 | 40 | 17 Rice | | 5 MC | 3 | 20 | 10 | 5 Abalyn |
| 24 | 40 | 17 Corn | | 5 MC | 3 | 15/5 | 10 | 5 Abalyn |
| | | | | | | sorbitol | | |
| 25 | 40 | 17 Corn | | 5 Nanoclay | 3 | 20 | 10 | 5 Abalyn |
| 26 | 40 | 17 Corn | | 5 MC | 3 | 20 | 10 | 5 Staybelite |
| 27 | 40 | 17 Corn | | 5 MC | 3 | 20 | 10 | 5 Permalyn |

Observations: adipic acid flows like water, butanediol is acceptable 3.0/5.0—loss in elongation. Mannitol slightly improved elongation and strength over butanediol 3.5/5.0. Proline/pipecolic acid exhibit different necking mechanism. No strain hardening observed. GMS, PCL diol show no significant compatibilizing effect. Nanoclay is suitable replacement for MC but environmental/degradation by-products may be a factor in aquatic toxicity.

Tackifier solvency: 1.5 g of Permalyn was dissolved in 6.0 g of glycerol, TEC, castor oil to check for solvency behavior. Castor oil showed the best solvency while TEC showed relatively good wetting and glycerol showed no wetting at room temperature. Stickiness of film could be due to bleeding/blooming of plasticizer out of film carrying tackifier. To overcome oily, sticky surface, lower plasticizer content may be beneficial improving tackifier efficiency. Addition of more polar Td modifier at low percentage in replacement of glycerol may also improve tackifier efficiency by pushing tackifier to surface. Presumably, polar Td modifiers can be completely bound by starch and will not bleed/bloom/leach to surface.

Tackifier selection: Abalyn shows less stickiness and oiliness. Presumably has good solvency with glycerol and poor with TEC. Abalyn may be more polar than Staybelite and Permalyn. Staybelite leads to very fast liquid like flow. Permalyn has greater flow than Abalyn but less than Staybelite. Permalyn also appears to provide increased strength ˜2 MPa based on tensile data. Permalyn has been selected for further screening

Starch selection: Hylon® VII provides better elongation and strength ˜20% increase but is a significant cost increase compared to native starches like corn and rice. Corn and rice appear to have more homogenous deformation behavior with better lateral stretch. Corn and rice also appear to produce smoother surfaces than Hylon® VII.

Co-Td modifier selection: Glycerol alone plasticized films exhibited the highest tensile strength and elongation. Sorbitol appears to provide increased lateral stretch in corn starch films but less effective in H7 films. Pipecolic acid and proline need to be screened again with corn starch as they are ineffective with H7 films. The high linearity of Hylon VII may increase elongation in the extruded direction but with limited branching, lateral stretch is sacrificed.

It may be possible to decrease TEC content to <5% to see if tack and oiliness are improved. Addition of 1-5% propylene glycol or short polyol that has poor solvency of tackifier may also improve tack. Disadvantage of short chain polyol such at butanediol or propylene glycol is low boiling point <200C. Solid long chain polyol, erythtritol, xylitol, and sorbitol should be explored. Amino acid derivatives may also be screened again and may improve water sensitivity while also potentially having crosslinking capabilities with boric acid.

In-house biodegradation mass loss: Compost set-up consists of 50:50 Miracle Gro potting soil/cow manure and ¼ teaspoon compost starter. ˜1.75″×⅛″ injection molded circular disk buried in compost and monitored weekly for mass loss. Smartplastics SPTek Eclipse bag also incubated in parallel.

TABLE 17

| | 0.5% Boric Acid | |
|---|---|---|
| Week | (formulation 2) (g) | % Mass Loss |
| 0 | 2.5271 | 0 |
| 1 | 2.0226 | 19.96 |
| 2 | 1.8926 | 25.11 |
| 3 | 1.8105 | 28.36 |

TABLE 18

| Week | Mass R1 | Mass R2 | Mass R3 | Mass R4 |
|---|---|---|---|---|
| 0 | .2761 | .2816 | .2714 | .2892 |
| 1 | .2755 | .2801 | .2710 | .2886 |
| 2 | .2759 | .2829 | .2745 | .2915 |

Observations: Visible mold growing on puck. Initial 20% mass loss is presumably glycerol leaching out. Puck it noticeably thinner at week 3. Expect puck to exhibit linear weight loss for subsequent weeks. At ˜3-5% mass loss weekly, puck should degrade within 6 months. No mass loss observed for Smartplastic bag within 2 weeks.

Tensile Data: Dog-bone specimens of ˜5.14mm width, 2.05 mm thickness, and 51.69mm gauge length extruded for testing. Testing performed at constant crosshead speed of 50 mm/min. Samples tested based on baseline formulation from preliminary results above. (+) symbol denoted that sample slipped out of grips before breaking. Strength and elongation are presumably higher.

40% PCL, 17% Starch, 3% Boric acid, 5% MC, 20% Glycerol, 10% TEC, 5% Abalyn

Results/observations: 30-40% increase in PCL leads to ˜2× elongation. Tipping point of compatibility between polar TPS and non-polar PCL. Based on film trials PCl content must be >35% for much improved tear resistance and lateral elongation. Hylon VII leads to increased tensile strength and elongation but minimal loss when complete replacement by native starches, rice and corn. Hylon® VII corn in ˜1:1 ratio leads to no significant advantages. Permalyn appears to have increased strength relative to Abalyn and Staybelite for the same formulation. Sorbitol co-Td modifier does not appear to significantly effect mechanical properties. 5% Boric acid leads to slight increase in tensile strength and elongation ˜20%.

### Example 5

### Cast-Film Extrusion Trials

Selected formulations were run on Xplore micro-compounder HT15 with Xplore cast-film pro line attachment. 80g batches were compounded in-house on Xplore micro-compounder HT15 and pelletized for film trials. Selected formulations were based on findings from EXP-22-IU9600, EXP-22-IU9601, EXP-22-IU9602. To begin casting, LLDPE was used to first purge and set up machine at temperature of 200° C.-220° C. and slowly lowered as selected formulations were added during material changeover.

TABLE 19
Trial 1 - selected formulations below
(percentages listed on weight basis)

| Formulation | PCL | H7 | Glycerol | Abalyn | Filler |
|---|---|---|---|---|---|
| 1 | 30 | 40 | 20 | 0 | 0 |
| 2 | 30 | 30 | 20 | 5 | 5 MC |
| 3 | 30 | 30 | 20 | 5 | 5 CS |

TABLE 20
Tensile Data

| Formulation | UTS | Elongation at break |
|---|---|---|
| 2 | 5.39765 | 294.856 |
| 2 | 5.10107 | 319.040 |
| 3 | 4.27067 | 202.248 |

### Processing Parameters

Zone 1-3 temperatures ˜140° C.
Torque—35.00 Nm max
Screw speed—18 rpm (variable based on torque)
Acceleration —100 rpm/s²
Die temperature—150C
Slit height—0.3 mm
Take-up roll speed (1)—250 rpm
Transport roll speed/Stretch-ratio (2)—287/1:1.15
Winder roll torque (3)—38

Set up: Due to small screws used to secure die to compounder, clean surfaces are a must and screws should be checked after machine is up to temperature. Air knife should be place as closely to die as possible to allow film to set-up sufficiently and avoid breakage. Air knife pressure seemed optimal when it was just high-enough not to cause film to be blown upward. Low air knife-pressure leads to drooping of film coming out of the die and difficulties loading through the rest of the rolls.

Results/observations: LLDPE and selected formulations appear to show some homogeneity allowing for ease of material changeover. Temperatures were dropped in 10° C. increments during material changeover to final processing temperature. Note load barrel slowly to avoid torque cut-off/motor shut-down.

Smooth-beige film produced on uniform thickness ˜0.4 mm. Loss of elongation overtime potentially due to moisture sensitivity. Poor elongation in transverse direction. Appears to exhibit two-phase composite behavior and fiber pull-out. Highly aligned and elongating PCL fibers in machine directions surrounded by poor elongation TPS matrix. A string-cheese effect is observed resulting in poor tear resistance in machine direction. This could be due to striations found in machine direction leading to thin spots. Thin spots may be a result of smoothness/imperfections of die machining or impurities/dirtiness of die itself. This is to be confirmed by cleaning the die. Best formulation for strength and elongation appears to by MC filled based on visual observations.

TABLE 21
Trial 2 - selected formulations below

| PCL | H7 | PVA | MC | Boric | TEC | Gly | Abalyn | Nanoclay |
|---|---|---|---|---|---|---|---|---|
| 40 | 15 | 5 | 5 | 5 | 10 | 15 | 5 | |
| 30 | 15 | 10 | 5 | 5 | 10 | 20 | 5 | |
| 20 | 20 | 15 | 5 | 5 | 10 | 20 | 5 | |
| 37.5 | 37.5 | | 6.25 | | | 18.75 | | 6.25 |

### Processing Parameters

Zone1-3 temperatures—180° C.
Torque—40.00 Nm max
Screw speed—35 rpm (variable based on torque)
Acceleration—100 rpm/s²
Die temperature—180° C.
Slit height—0.3 mm
Take-up roll speed (1)—460
Transport roll speed/Stretch-ratio (2)—496/1:1.08
Winder roll torque (3)—38

Results/observations: 40% PCL yielded best lateral/traverse direction stretch. 20% PCL appears to phase separate. No film was obtained. Filament compounded shows <100% elongation. PVA/boric acid appears to not have fully melted. Small crystals observed on surface leading to defects and poor homogeneity and inconsistent mechanical properties. Some regions stretch better than others. Tack of film is minimal and does not readily self adhere.

Boric acid seems to provide significant advantages in transverse direction in comparison to uncrosslinked film. Last formulation contains ˜2.5% v/w 30% hydrogen peroxide solution with ˜2.5% iron gluconate catalyst. Film is noticeably darker in color with brownish hue. Improved lateral stretch in comparison to uncrosslinked film but less pronounced than boric acid based on visual observations.

Selected formulations are limited in processing temperature range by glycerol boiling point ˜210° C., boric acid melting point ˜170° C., and PVA melting point >200° C. Further trials can be run at >170° C. without PVA to avoid poor/incomplete melting of components (PVA, boric acid).

During operations, take-up speed should be monitored and adjusted based on flow. If film starts to droop in the middle and lead to overlapping, problem was resolved by increasing the take-up speed. High stretch-ratio were not very effective at producing thinner film presumably because film solidifies rather quickly in air after going through take-up roll. The secondary roll the pinches the film onto the take-up roll will slip and open up, presumably not enough force to pinch the film to the take-up roll allowing for stretch between the take-up and transport roll. To achieve thinner film, higher take-up speeds were more efficient. At low speeds where film droop and overlap were not present the thickest films produced were ˜300 gauge while thin films produced without tearing were ˜100 gauge.

TABLE 22
Trial 3 - selected formulations below

| | Corn | | | | | | |
|---|---|---|---|---|---|---|---|
| PCL | Starch | MC | Boric | TEC | Gly | Tackifier | Sorbitol |
| 40 | 17 | 5 | 3 | 10 | 20 | 5 Abalyn | |
| 40 | 19 | 5 | 3 | 8 | 20 | 5 Permalyn | |
| 35 | 22 | 5 | 5 | 8 | 15 | 5 Permalyn | 5 |
| 35 | 21 | 5 | 3 | 8 | 20 | 8 Permalyn | |

### Processing Parameters

Zone 1-3 temperatures—170° C.
Torque—40.00 Nm
Screw speed—50 rpm
Accelerations—100 rpm/s²
Die temperature—180° C.
Slit height—0.3 mm
Take-up roll speed (1)—990
Transport roll speed/Stretch-ratio (2)—1108/1:1.12
Winder roll torque (3)—47

Results/observations: Permalyn tackifier produced stickier film than Abalyn. However, Permalyn appears to bleed/bloom to surface leaving hands oily/sticky. Permalyn also tends to increase melt flow. Plasticizer needs to be adjusted to increase viscosity and decrease flow for ease of processing. 8% tackifier was to sticky and difficult to cast as film stuck to rolls. Chilled rolls may help alleviate sticking. 8% appears to be too high-loading although film readily sticks to itself. 5% was semi-sticky but still less than compared to PE stretch-film. 35% PCL resulted in string-cheese effect and poor machine direction tear resistance. Lateral elongation was acceptable ˜100-200%. Poor tear strength may be a result of die imperfections or dirtiness to be addressed next trial. Clear striations and thin spots are observed along the machine direction leading to a fluted surface. When elongating in the transverse direction, this fluted pattern is more exaggerated and film will fail in the thin regions. When film is stretched in the machine direction monodisperse necking regions form and stretch looks very uniform. More uniform than Hylon® VII from previous trials where large white necking regions are more confined.

Corn starch appears to provide superior advantage over Hylon® VII providing more uniform deformation behavior, increased surface smoothness, and greater transverse direction stretch. Rice starch or smaller more monodisperse starches should be screened for surface roughness. Rice starch should be more monodisperse with granule size between 3-8 μm v. corn starch granule size of 5-25 μm. High-amylose starch may result in distribution of granule size on the higher-end closer to 25 μm.

Permalyn tack will need to be increased slightly while decreasing flow or due to potential bleeding/blooming, Permalyn tackifier could be decreased allowing for greater surface smoothness leading to better tack. More screening to be completed to determine if tackifier concentration is too high/low. Permalyn can be checked for solvency behavior is plasticizers. Should have greater affinity for glycerol (polar) or TEC (non-polar), additional plasticizers, tributyl acetyl citrate and castor oil can be screened for solvency behavior.

Td modifier screening can be continued to potentially replace glycerol allowing for increased processing temperature range. This may allow for cost-reduction by incorporating PVA. Amino acid derivatives, pipecolic acid, proline, choline may be potential Td modifiers. High thermal stability polyols with increased boiling points such as erythritol, xylitol, sorbitol may be potential substitutes for glycerol.

All references cited in this specification are herein incorporated by reference as though each reference was specifically and individually indicated to be incorporated by reference. The citation of any reference is for its disclosure prior to the filing date and should not be construed as an admission that the present disclosure is not entitled to antedate such reference by virtue of prior invention.

It will be understood that each of the elements described above, or two or more together may also find a useful application in other types of methods differing from the type described above. Without further analysis, the foregoing will so fully reveal the gist of the present disclosure that others can, by applying current knowledge, readily adapt it for various applications without omitting features that, from the standpoint of prior art, fairly constitute essential characteristics of the generic or specific aspects of this disclosure set forth in the appended claims. The foregoing embodiments are presented by way of example only; the scope of the present disclosure is to be limited only by the following claims.

1. A biodegradable thermoplastic material comprising (a) 20% to 90% by weight a biodegradable polymer and (b) 3% to 40% by weight a plasticizer, (c) 1% to 20% by weight a crosslinker,
wherein the biodegradable thermoplastic material optionally further comprises (d) 10% to 50% by weight a biodegradable polyol; (e) 0% to 20% by weight a filler; (f) 1% and 15% by weight a tackifier, or a combination thereof.

2. (canceled)

3. The material of claim 1, wherein the biodegradable polymer is poly(ε-caprolactone) average Mₙ 80,000 (PCL-Mₙ80K); polyethylene glycol 400 (PEG 400); polyethylene glycol 1500 (PEG 1500); polyvinyl alcohol MW 13,000-23,000;
polyvinyl alcohol MW 85,000-146,000; polycaprolactone diol MW=1 kDa to 3 kDa, polyhydroxybutyrate (PHB) MW 20 kDa to 50 kDa; polylactic acid (PLA); or a mixture thereof.

4. The material of claim 1, wherein the biodegradable polymer is a copolymer.

5. (canceled)

6. (canceled)

7. The material of claim 1, wherein the biodegradable polymer is in an amount of 20% to 90% by weight; 20% to 60% by weight, 30% to 50% by weight, 35% to 45% by weight, 32% to 45% by weight, 35% to 60% by weight, 33% to 49% by weight, 30% to 40% by weight, 35% to 45% by weight, or 36% to 57% by weight.

8. (canceled)

9. The material of claim 1, wherein the biodegradable polymer is in an amount of about 40% by weight.

10. The material of claim 1, wherein the biodegradable polymer is poly(ε-caprolactone) (PCL) MW 80,000 and about 40% by weight.

11. (canceled)

12. The material of claim 1, wherein the biodegradable polyol is corn (maize) starch.

13. The material of claim 1, wherein the biodegradable polyol is in an amount of 1% to 30% by weight, 10% to 50% by weight;
10% to 20% by weight, 15% to 27% by weight, 12% to 25% by weight, or 15% to 30% by weight, 13% to 29% by weight, 14% to 22% by weight, 15% to 25% by weight, or 16% to 27% by weight.

14-17. (canceled)

18. The material of claim 1, wherein the filler is carboxymethyl cellulose, hydroxyethyl cellulose, chitosan, cellulose acetate, cellulose acetate propionate, hydroxypropyl methyl cellulose, hydroxypropyl cellulose, methyl cellulose, microcrystalline cellulose (MCC), or a combination thereof.

19-20. (canceled)

21. The material of claim 1, wherein the filler is in an amount of 0% to 20% by weight; 1% to 20% by weight, 1% to 10% by weight, 1% to 17% by weight, 1% to 15% by weight, or 5% to 10% by weight, 3% to 9% by weight, 4% to 12% by weight, 5% to 20% by weight, or 6% to 17% by weight.

22-24. (canceled)

25. The material of claim 1, wherein the crosslinker is glutaraldehyde, glyoxal, succinic anhydride, maleic anhydride, boric acid, citric acid, potassium persulphate, hydrogen peroxide, benzoyl peroxide, or a combination thereof.

26-31. (canceled)

32. The material of claim 1, wherein the plasticizer is in an amount of about 1% to 50% by weight.

33-40. (canceled)

41. The material of claim 1, wherein the plasticizer is a melting temperature modifier.

42-44. (canceled)

45. The material of claim 41, wherein the material comprises 1% to 30% by weight a melting point modifier.

46-49. (canceled)

50. The material of claim 1, wherein the plasticizer is a lubricant.

51-52. (canceled)

53. The material of claim 50, wherein the lubricant is in an amount of 1% to 10% by weight, 3% to 30% by weight, 4% to 7% by weight, 5% to 8% by weight, or 6% to 7% by weight, 13% to 20% by weight, 4% to 17% by weight, 5% to 20% by weight, or 6% to 17% by weight.

54-59. (canceled)

60. The material of claim 1, wherein the tackifier is terpene, rosin methyl ester, partially hydrogenated rosin ester, hydrogenated gum rosin alcohol, gum rosin, Eastman Permalyn 6110 Synthetic resin® (pentaerythritol ester of rosin), pentaerythritol gum rosin ester, beeswax, plant oils, or a combination thereof.

61. (canceled)

62. The material of claim 1, wherein the tackifier is in an amount of 1% to 10% by weight, 3% to 10% by weight, 4% to 7% by weight, 1% to 15% by weight, 5% to 8% by weight, or 6% to 7% by weight.

63-66. (canceled)

67. Packaging comprising the material of claim 1.

68-70. (canceled)

71. A method for making the material of claim 1 comprising mixing the components and extrude to produce the material of claim 1, optionally molding the material into pellets.

72-79. (canceled)
